(19) United States
(12) Patent Application Publication
(10) Pub. No.: US 2017/0251043 A1
(43) Pub. Date: Aug. 31, 2017

(54) COMMUNICATION DEVICE, METHOD OF CONTROLLING WEB ACCESS, AND COMPUTER READABLE MEDIUM

(71) Applicant: CASIO COMPUTER CO., LTD., Tokyo (JP)

(72) Inventor: Hirokazu Kanda, Tokyo (JP)

(21) Appl. No.: 15/395,043

(22) Filed: Dec. 30, 2016

(30) Foreign Application Priority Data
Feb. 29, 2016 (JP) 2016-037868

(51) Int. Cl. H04L 29/08; H04W 4/00; H04W 40/24

(52) U.S. Cl. CPC H04L 67/02; H04W 40/244; H04W 4/008

(57) ABSTRACT

A communication device includes: a receiving section which receives beacon information; and a control section which controls access to a predetermined Web page based on an elapsed time from reception of the beacon information.

### CROSS-REFERENCE TO RELATED APPLICATION

This application is based upon and claims the benefit of priority from the prior Japanese Patent Application No. 2016-037868 filed on Feb. 29, 2016, the entire contents of which are incorporated herein by reference.

### BACKGROUND OF THE INVENTION

Field of the Invention

The present invention relates to a communication device, a method of controlling Web access, and a computer readable medium.

Description of the Related Art

Systems have been known that provide commercial information on the basis of ID information included in beacon information received by communication devices, such as portable terminals. For example, Japanese Patent Application Laid-Open Publication No. 2009-188922 discloses a system in which a terminal device detects radio beacons emitted from access point devices disposed throughout a town, collects SSIDs, and transmits a history of such detection to a server device in response to a user operation, and the server device transmits commercial information correlated to the SSIDs contained in the received history to the terminal device.

Another system is also known for motivating a customer to visit a store. In the system, a beacon which transmits beacon information containing ID information corresponding to a predetermined Uniform Resource Locator (URL) is installed in the store, and if a communication device which has received the beacon information accesses the URL corresponding to the ID information, useful services, such as a coupon, are provided to the communication device.

### SUMMARY OF THE INVENTION

Unfortunately, according to the conventional technology, once the ID information is stored in the communication device, the communication device can access the Web page of the URL corresponding to the ID information and receive the service anytime and anywhere in response to a user operation. Such technology cannot motivate a customer to revisit to a store.

An object of the present invention is to enable restricting a customer from accessing a Web page on the basis of received beacon information.

To solve the above problems, a communication device in which one aspect of the present invention is reflected includes: a receiving section which receives beacon information; and a control section which controls access to a predetermined Web page based on an elapsed time from reception of the beacon information.

According to the present invention, it becomes possible to restrict a customer from accessing a Web page on the basis of received beacon information.

### BRIEF DESCRIPTION OF THE SEVERAL VIEWS OF THE DRAWINGS

The above and further objects, features and advantages of the present invention will be made clearer by the following detailed description and the attached drawings, in which:

FIG. 1 illustrates an overall configuration of a service providing system according to this embodiment.

FIG. 2 is a block diagram illustrating a functional configuration of a digital signage device in FIG. 1.

FIG. 3 illustrates a schematic configuration of a screen section in FIG. 2.

FIG. 4 is a block diagram illustrating a functional configuration of a portable terminal in FIG. 1.

FIG. 5 is a flow chart illustrating a Web access controlling process carried out by a control section in FIG. 3.

### DETAILED DESCRIPTION OF THE PREFERRED EMBODIMENTS

Hereinafter preferred embodiments of the present invention will be described with reference to the accompanying drawings. The communication device according to the present invention is exemplified by a portable terminal 2 in the embodiment described below. The present invention is not limited to the illustrated examples.

### [Configuration of Service Providing System 100]

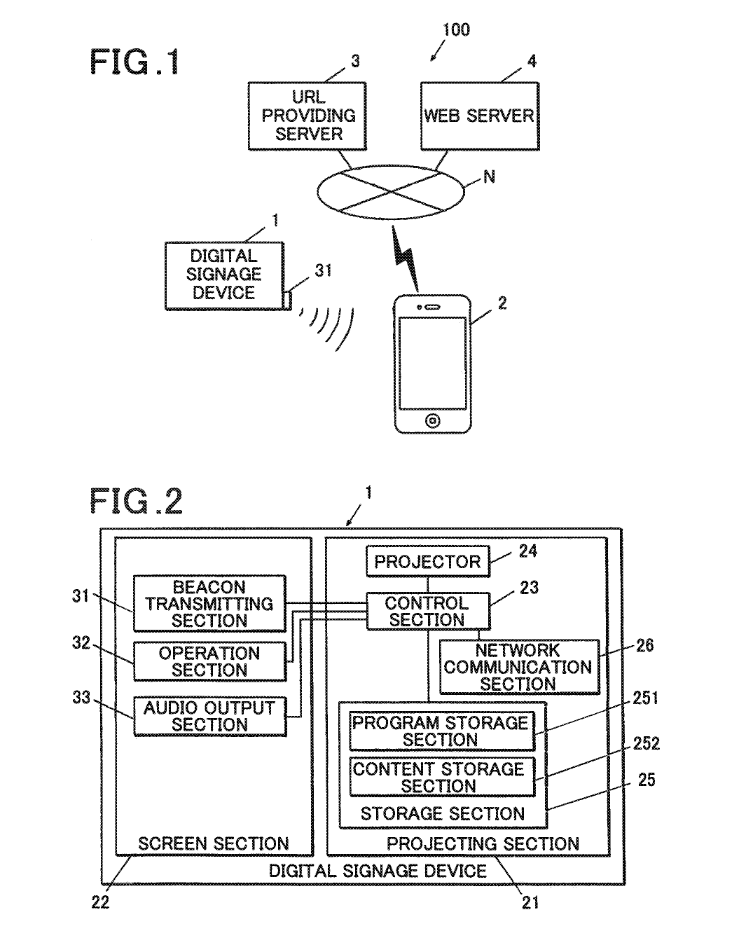

FIG. 1 illustrates an overall configuration of a service providing system 100 according to an embodiment of the present invention. The service providing system 100 provides services, such as a coupon, to a user of the portable terminal 2 who has entered a communication area of a beacon transmitting section 31 of a digital signage device 1 installed in a store. With reference to FIG. 1, the service providing system 100 includes a digital signage device 1, a portable terminal 2, a URL providing server 3, and a Web server 4. The beacon transmitting section 31 of the digital signage device 1 and the portable terminal 2 can establish short-range wireless communication between each other using Bluetooth® technology. The portable terminal 2 can be communicably connected to the URL providing server 3 and/or the Web server 4, and vice versa, via a communication network N including a wireless Local Area Network (LAN), a mobile communication network, and an internet.

### [Configuration of Digital Signage Device 1]

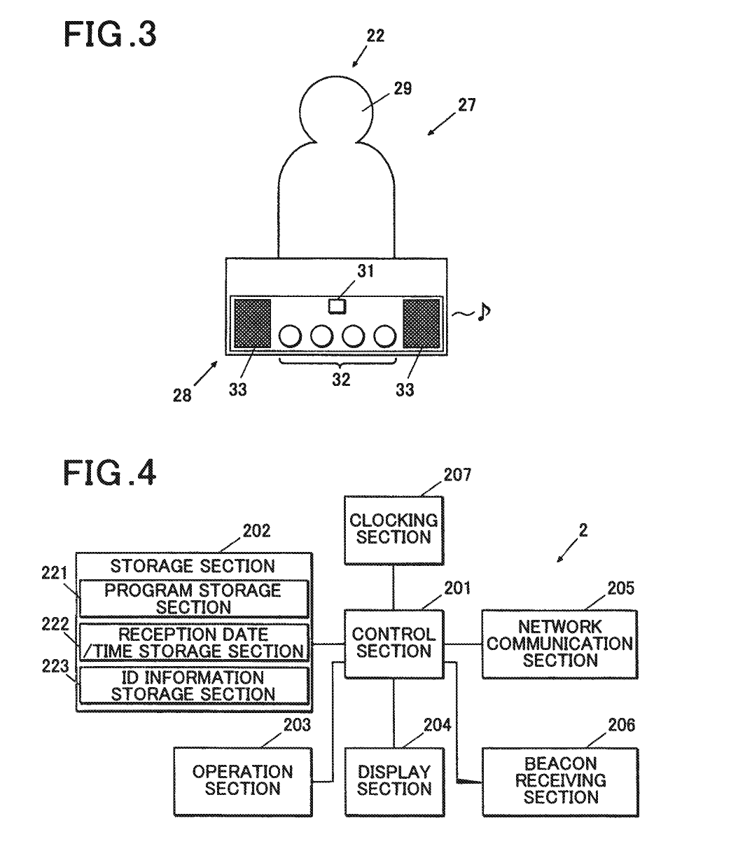

FIG. 2 is a block diagram illustrating a main control configuration of the digital signage device 1 according to this embodiment. FIG. 3 is a front view of a schematic configuration of a screen section 22 in FIG. 2. The digital signage device 1 is installed in a store, for example, and outputs content including a product description to customers.

With reference to FIG. 2, the digital signage device 1 includes a projecting section 21 that emits image light of the content, and the screen section 22 that receives, from the projecting section 21, the image light on the back face thereof so that the image light is projected on the front face of the screen section 22.

The projecting section 21 will now be described.

The projecting section 21 includes a control section 23, a projector 24, a storage section 25, and a network communication section 26. The projector 24, the storage section 25, and the network communication section are connected to the control section 23, as illustrated in FIG. 2.

The control section 23 includes a Central Processing Unit (CPU) and a memory (both not shown). The CPU executes various programs stored in the storage section 25 to carry out predetermined calculation processes and control of the sections. The memory provides a work area for the execution of the programs. The control section 23 operates in cooperation with programs stored in a program storage section 251 of the storage section 25 to control the projector 24 and/or an audio output section 33 to output the content related to products in the store. The control section 23 also instructs the beacon transmitting section 31 to transmit beacon information containing predetermined ID information at predetermined time intervals.

The projector 24 converts image data of the content output from the control section 23 into image light and emits the image light to the screen section 22. The projector 24 may be, for example, a Digital Light Processing (DLP)® projector including a Digital Micromirror Device (DMD), which is a display device that forms an optical image with light reflected at an array of micromirrors (1024 W×768 H pixels for XGA) individually rotated by a predetermined degree at high speed between ON and OFF states.

The storage section 25 includes a hard disk drive (HDD) and a non-volatile semiconductor memory. With reference to FIG. 2, the storage section 25 includes the program storage section 251 and a content storage section 252.

The program storage section 251 stores a system program and various programs to be executed by the control section 23, data required for the execution of the programs, and so on.

The content storage section 252 stores content data of the content to be output by the digital signage device 1. The content data mainly contains video data consisting of multiple frame images and audio data corresponding to the frame images. Alternatively, the content data may include only image data (still image data or video image data) or only audio data.

The network communication section 26 is composed of a modem, a router, a network card, and so on, and communicates with external devices via the communication network.

The screen section 22 will now be described.

With reference to FIG. 3, the screen section 22 includes an image forming section 27 and a base 28 supporting the image forming section 27.

The image forming section 27 is a screen including a single light transmissive plate 29, which is composed of an acrylic plate shaped into a human form, for example, and disposed substantially orthogonal to the incident direction of the image light, and a film screen for back projection, which includes a laminated Fresnel lens film and is bonded to the light transmissive plate 29. The image forming section 27 may have any shape other than the human form.

The base 28 includes a beacon transmitting section 31, a button type operation section 32, and the audio output section 33 that outputs audio signals, such as a speaker.

The beacon transmitting section 31 broadcasts beacon information containing previously-set ID information at predetermined time intervals at a previously-set intensity through a Bluetooth Low Energy (BLE) communication scheme. The ID information identifies services that can be received by the portable terminal 2.

The beacon transmitting section 31, the operation section 32, and the audio output section 33 are connected to the control section 23, as illustrated in FIG. 2.

### [Configuration of Portable Terminal 2]

FIG. 4 is a block diagram illustrating a main control configuration of the portable terminal 2. The portable terminal 2 is a communication device carried by a customer, such as a smart phone or a mobile phone. The portable terminal 2 includes a control section 201, a storage section 202, an operation section 203, a display section 204, a network communication section 205, a beacon receiving section 206, and a clocking section 207, as illustrated in FIG. 4.

The control section 201 includes a CPU and a memory (both not shown). The CPU executes the various programs stored in a program storage section 221 of the storage section 202, to carry out predetermined calculation processes and control of the sections. The memory serves as a work area during execution of the programs. The control section 201 operates in cooperation with application programs stored in the program storage section 221 of the storage section 202 to perform a Web access controlling process, as described below.

The storage section 202 includes a non-volatile semiconductor memory. The storage section 202 includes the program storage section 221, as illustrated in FIG. 4. The program storage section 221 stores a system program executed by the control section 201, an application program for performing the Web access controlling process, as described below, a Web browser for browsing the Web, firewall software, and data required for execution of such programs.

The storage section 202 is provided with a reception date/time storage section 222 that stores the date and time of reception of the beacon information, and an ID information storage section 223 that stores the ID information included in the received beacon information.

The operation section 203 includes various function keys, receives input of each key pressed by a user, and outputs operation information on the keys to the control section 201. The operation section 203 includes a touch panel provided with a grid of transparent electrodes covering the surface of the display section 204. The operation section 203 detects the position pressed by a finger or a stylus on the touch panel, and outputs positional information as the operation information to the control section 201.

The display section 204 includes a liquid crystal display (LCD) and performs various kinds of displays, on a screen, according to display control signals from the control section 201.

The network communication section 205 is wirelessly connected to the communication network N via a base station or an access point, to communicate with external devices connected to the communication network N.

The beacon receiving section 206 establishes short-range wireless communication with an external beacon transmitter, for example, the beacon transmitting section of the digital signage device 1, through a BLE communication scheme, and receives the beacon information transmitted from the beacon transmitter. The beacon receiving section 206 detects the intensity of the radio wave received through Bluetooth communication, and outputs the detected information to the control section 201. The beacon receiving section 206 functions as a receiving section.

The clocking section 207 is composed of a real time clock (RTC) and the like, receives the current date and time, and outputs them to the control section 201.

### [Configuration of URL Providing Server 3]

The URL providing server 3 is a computer device including a control section, a storage section, an operation section, a display section, and a communication section. The storage section of the URL providing server 3 stores the ID information, and the URL accessible by the portable terminal 2 that has received the ID information, the ID information and the URL being correlated to each other. When the URL providing server receives the ID information and a request for transmission of the URL corresponding to the ID information from the portable terminal 2, the URL providing server 3 refers to the storage section, reads the URL corresponding to the ID information, and sends the URL to the portable terminal 2.

### [Configuration of Web Server 4]

The Web server 4 retrieves information for displaying the Web page from a storage area corresponding to the URL assigned by the Web browser installed in the portable terminal 2, and sends the information to the portable terminal 2. A Web page according to this embodiment provides a coupon, for example.

### [Operation of Service Providing System 100]

The operation of the service providing system 100 will now be described.

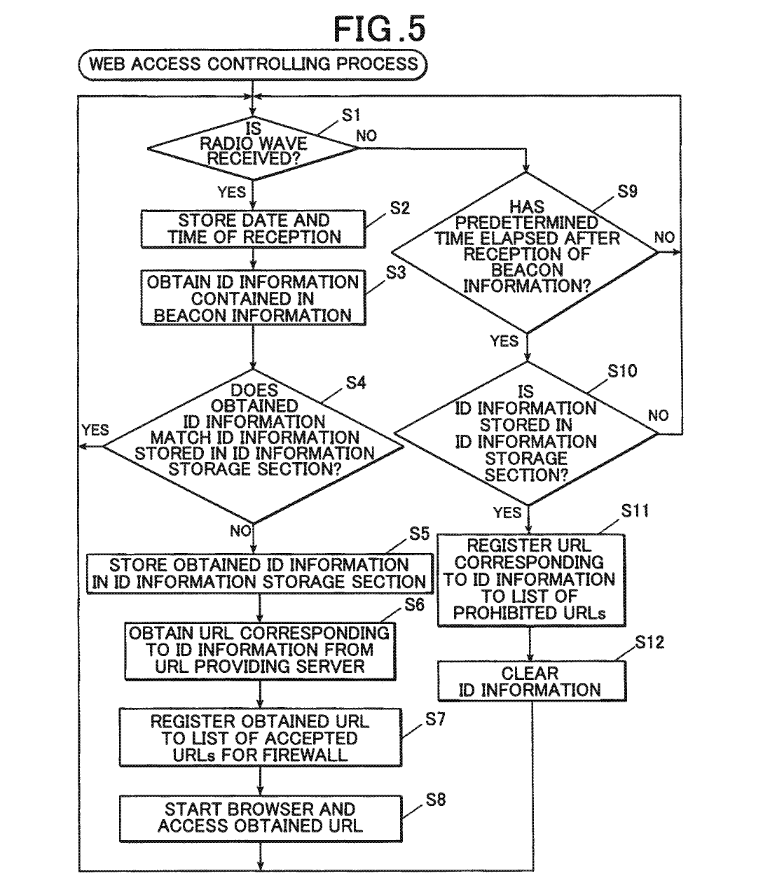

FIG. 5 is a flow chart illustrating the Web access controlling process carried out in the portable terminal 2. The Web access controlling process is carried out by the control section 201 in cooperation with the application program stored in the program storage section 221.

The control section 201 determines whether the beacon receiving section 206 receives the radio wave (Step S1). Concretely, the control section 201 determines whether the radio wave transmitted from the beacon transmitting section 31 of the digital signage device 1 is received.

If the control section 201 determines that the beacon receiving section 206 receives the radio wave (Step S1: YES), the control section 201 acquires the current date and time from the clocking section 207 and stores them as the date and time of reception (i.e., updates the date and time) in the reception date/time storage section 222 (Step S2).

The control section 201 obtains the ID information contained in the beacon information of the radio wave received by the beacon receiving section 206 (Step S3) and determines whether the obtained ID information matches the ID information stored in the ID information storage section 223 (Step S4).

If the control section 201 determines that the obtained ID information matches the ID information stored in the ID information storage section 223 (Step S4: YES), the control section 201 returns to the process of Step S1.

If the control section 201 determines that the obtained ID information does not match the ID information stored in the ID information storage section 223 (Step S4: NO), the control section 201 stores the obtained ID information in the ID information storage section 223 (i.e., updates the ID information) (Step S5).

The control section 201 then obtains the URL corresponding to the ID information from the URL providing server 3 (Step S6). Concretely, the control section 201 instructs the network communication section 205 to send the obtained ID information to the URL providing server 3 to request transmission of the URL corresponding to the ID information, and obtains the URL corresponding to the ID information from the URL providing server 3.

The control section 201 registers the obtained URL to a list of URLs accepted by the firewall (Step S7). The control section 201 then starts up the browser, allows access to the Web server 4 by the obtained URL, and instructs the display section 204 to display the Web page (Step S8). The control section 201 then returns to the process of Step S1.

In Step S2, if the control section 201 determines that the beacon receiving section 206 has not received the radio wave (Step S1: NO), the control section 201 refers to the reception date/time storage section 222 and determines whether a predetermined time has elapsed from reception of the beacon information (Step S9).

If the control section 201 determines that the predetermined time has not elapsed since reception of the beacon information (Step S9: NO), the control section 201 returns to the process of Step S1.

If the control section 201 determines that the predetermined time has elapsed since reception of the ID information (Step S9: YES), the control section 201 determines whether the ID information is stored in the ID information storage section 223 (Step S10).

If the control section 201 determines that the ID information is not stored in the ID information storage section 223 (Step S10: NO), the control section 201 returns to the process of Step S1.

If the control section 201 determines that the ID information is stored in the ID information storage section 223 (Step S10: YES), the control section 201 registers the URL corresponding to the ID information stored in the ID information storage section 223 to a list of URLs prohibited by the firewall (Step S11). Once the predetermined time elapses after reception of the last beacon information, the user cannot access the Web page with the browser by assigning the URL corresponding to the beacon information received from the digital signage device 1. For the user to access the Web page of the URL corresponding to the beacon information, the user needs to revisit the store with the portable terminal 2 and enter the area where the radio wave can be transmitted from the beacon transmitting section 31 of the digital signage device 1. This motivates the user to revisit the store.

After that, the control section 201 clears the ID information stored in the ID information storage section 223 (Step S12) and returns to the process of Step S1.

The control section 201 repeats the processes of Steps S1 to S12 during activation of the application program.

As described above, in the portable terminal 2 of the service providing system 100, the control section 201 controls access to the Web page correlated to the ID information included in the beacon information on the basis of the elapsed time from reception of the beacon information by the beacon receiving section 206 from the digital signage device 1. For example, if a predetermined time has not elapsed since reception of the beacon information, access is permitted to the Web page of the URL correlated to the received beacon information, whereas, if the predetermined time has elapsed since reception of the beacon information, access is blocked to the Web page of the URL correlated to the received beacon information.

Thus, the access to the Web page based on the beacon information received by the portable terminal 2 can be restricted so that the accessible time falls within a predetermined time period after reception of the beacon information. If the user wants to access the Web page in order to receive the service after the predetermined time elapses after reception of the beacon information, the user needs to revisit, with the portable terminal 2, the store where the digital signage device 1 is installed. This motivates the user to revisit the store.

The embodiment described above, which exemplifies a service providing system according to the present invention, should not be construed to limit the present invention.

For example, in the embodiment described above, after a predetermined time after reception of the beacon information, the status of the URL correlated to the ID information of the received beacon information is switched from an acceptable URL to a prohibited URL for the firewall so as to control access to the Web page of the URL correlated to the beacon information. However, the method of controlling access to the Web page should not be limited thereto. For example, when the operation section 203 receives an instruction to access the Web page of the URL correlated to the ID information of the received beacon information, the control section 201 adds the date and time of reception of the beacon information to be a parameter at the end of the URL and then starts the Web browser. The control section 201 can thereby carry out control so that a user accesses a Web page different from the Web page of the instructed URL in the Web server 4 if a predetermined time has elapsed from the date and time of reception. In this way, similar to the embodiment described above, the access to the Web page based on the beacon information received by the portable terminal 2 can be limited so that the accessible time falls within a predetermined time period after reception of the beacon information. Thus, if the user wants to access the Web page in order to receive the service after the predetermined time elapses after reception of the beacon information, the user needs to revisit, with the portable terminal 2, the store where the digital signage device 1 is installed. This motivates the user to revisit the store. Moreover, the accessed Web page may indicate the time period during which the Web page is accessible based on the date and time of reception of the beacon information.

In the embodiment described above, access to the Web page is controlled on the basis of the time that has elapsed since reception of the beacon information. However, the present invention should not be limited thereto. Alternatively, for example, when the operation section 203 receives an instruction to access the Web page of the URL correlated to the ID information of the received beacon information, the control section 201 detects the intensity of the radio wave by the beacon receiving section 206. If the detected intensity of the radio wave is equal to or higher than a predetermined intensity, access is permitted to the Web page of the URL correlated to the ID information, whereas if the detected intensity is lower than the predetermined intensity, access is prohibited to the Web page of the URL correlated to the ID information. Alternatively, a Web page other than the Web page of the instructed URL may be accessed. In this way, if the user wants to access the Web page of the URL correlated to the beacon information, a user needs to enter, with the portable terminal 2, an area in which the radio wave from the beacon transmitting section 31 of the digital signage device 1 has an intensity equal to or higher than a predetermined intensity. This motivates the user to revisit the store.

A pop-up display may appear on the display section 204 after reception of the beacon information, and the pop-up display may indicate the time period during which the Web page is accessible.

The detailed configuration and operation of the components constituting the service providing system may be modified in various ways without departing from the scope of the invention.

The embodiments described above should not be construed to limit the present invention, and the claims and other equivalents thereof are included in the scope of the invention.

What is claimed is:

1. A communication device comprising:
a receiving section which receives beacon information; and
a control section which controls access to a predetermined Web page based on an elapsed time after reception of the beacon information.

2. The communication device according to claim 1, wherein the control section controls access to the Web page correlated to the beacon information based on the elapsed time from reception of the beacon information.

3. The communication device according to claim 2, wherein the control section permits access to the Web page of a URL correlated to the beacon information if the elapsed time from reception of the beacon information does not exceed a predetermined time period, and prohibits the access to the Web page of the URL correlated to the beacon information if the time elapsed from reception of the beacon information exceeds the predetermined time period.

4. The communication device according to claim 2, wherein, in response to an instruction to access the Web page of a URL correlated to the beacon information, the control section carries out control for accessing another Web page different from the predetermined Web page if the elapsed time from reception of the beacon information exceeds a predetermined time period.

5. The communication device according to claim 1, further comprising:
a display section which displays a time during which the Web page of a URL correlated to the beacon information is accessible, when the receiving section receives the beacon information.

6. A method of controlling Web access comprising:
receiving beacon information; and
controlling access to a predetermined Web page based on an elapsed time from reception of the beacon information.

7. A non-transitory computer readable medium storing a program for causing a computer to execute a process, the process comprising:
receiving beacon information; and
controlling access to a predetermined Web page based on an elapsed time from reception of the beacon information.
